(19) United States
(12) Patent Application Publication
(10) Pub. No.: US 2025/0348155 A1
(43) Pub. Date: Nov. 13, 2025

(54) TRACKING SYSTEM AND METHOD

(71) Applicant: HTC Corporation, Taoyuan City (TW)

(72) Inventors: Chao-Shuan HUANG, Taoyuan City (TW); Wen-Shan YANG, Taoyuan City (TW); Hao-Yun CHAO, Taoyuan City (TW)

(21) Appl. No.: 19/206,058

(22) Filed: May 13, 2025

Related U.S. Application Data
(60) Provisional application No. 63/645,962, filed on May 13, 2024.

(51) Int. Cl. G06F 3/0346; A63F 13/211; A63F 13/216; A63F 13/22; A63F 13/245; G06F 3/01; G06F 3/038

(52) U.S. Cl. CPC G06F 3/0346; A63F 13/211; A63F 13/216; A63F 13/22; A63F 13/245; G06F 3/011; G06F 3/038

(57) ABSTRACT

A tracking system and method are provided. A movable element of the tracking system performs a motion process on a movable path. A tracking device of the tracking system calculates a signal change at each of time points corresponding to the motion process based on first sensing signals and second sensing signals. The tracking device generates a variable extrinsic calibration parameter of a target device and the movable element corresponding to each of the time points based on the signal changes and the fixed motion relationship. The tracking device performs a tracking operation corresponding to the target device based on the variable extrinsic calibration parameters.

### CROSS-REFERENCE TO RELATED APPLICATION

This application claims priority to U.S. Provisional Application Ser. No. 63/645,962, filed May 13, 2024, which is herein incorporated by reference in its entirety.

### BACKGROUND

### Field of Invention

The present disclosure relates to a tracking system and method. More particularly, the present disclosure relates to a tracking system and method that can correctly perform tracking operations.

### Description of Related Art

In recent years, various technologies related to virtual reality have developed rapidly, and various electronic device technologies and applications have been proposed one after another.

In the prior art, accurate object tracking can be achieved by installing a tracking system with a transmitter or a sensor on the target device/object to be tracked. However, in such a setup, the sensor, the transmitter, and the target device/object must be fixed in a rigid body (i.e., fixed, immovable position) and calibrated via pose/position/extrinsic calibration parameters between the tracking system and the target device that are known at manufacturing time.

Therefore, if the tracking system is not fixed to the target device, there is relative motion between the tracking system and the target device, or the tracking system and the target device are movable during use/tracking, the position/pose of the target device will not be tracked correctly.

Accordingly, there is an urgent need for a tracking technology that can correctly perform tracking operations.

### SUMMARY

An objective of the present disclosure is to provide a tracking system. The tracking system comprises a moving part, a target device, and a movable element. The moving part comprises a movable path. The target device comprises a first micro electro mechanical system sensor, and the first micro electro mechanical system sensor is configured to generate a plurality of first sensing signals. The movable element is disposed on the moving part, the movable element comprises a tracking device and a second micro electro mechanical system sensor, and the second micro electro mechanical system sensor is configured to generate a plurality of second sensing signals. The movable element performs a motion process on the movable path, the movable element and the target device have a fixed motion relationship in the motion process. The tracking device calculates a signal change at each of a plurality of time points corresponding to the motion process based on the first sensing signals and the second sensing signals. The tracking device generates a variable extrinsic calibration parameter of the target device and the movable element corresponding to each of the time points based on the signal changes and the fixed motion relationship. The tracking device performs a tracking operation corresponding to the target device based on the variable extrinsic calibration parameters.

Another objective of the present disclosure is to provide a tracking method, which is adapted for use in a tracking system. The tracking system comprises a moving part, a target device, and a movable element. The moving part comprises a movable path, the target device comprises a first micro electro mechanical system sensor, and the first micro electro mechanical system sensor is configured to generate a plurality of first sensing signals. The movable element is disposed on the moving part, the movable element comprises a tracking device and a second micro electro mechanical system sensor, the second micro electro mechanical system sensor is configured to generate a plurality of second sensing signals. The tracking method comprises following steps: performing, by the movable element, a motion process on the movable path, wherein the movable element and the target device have a fixed motion relationship in the motion process; calculating, by the tracking device, a signal change at each of a plurality of time points corresponding to the motion process based on the first sensing signals and the second sensing signals; generating, by the tracking device, a variable extrinsic calibration parameter of the target device and the movable element corresponding to each of the time points based on the signal changes and the fixed motion relationship; and performing, by the tracking device, a tracking operation corresponding to the target device based on the variable extrinsic calibration parameters.

According to the above descriptions, the tracking technology (at least including the system and the method) provided by the present disclosure limits the motion process of the target device to be tracked and the movable element (i.e., predefined moving parts and movable paths), so that the movable element and the target device to be tracked have a fixed motion relationship within the motion process. Next, the tracking technology disclosed in the present disclosure collects sensing signals through the micro electro mechanical system sensors disposed on the target device to be tracked and the movable element, and generates variable extrinsic calibration parameters of the target device and the movable element corresponding to each of a plurality of time points based on the signal changes. Finally, the tracking technology disclosed in the present disclosure can perform a tracking operation corresponding to the target device during the motion process (e.g., a plurality of preset calibration frequencies/time points) based on the variable extrinsic calibration parameters. Since the present disclosure can calibrate the target device to be tracked when the movable element performs a motion process, the problem that the target device to be tracked and the tracking device cannot be calibrated in the conventional technology is solved. In addition, the tracking technology provided by the present disclosure can also improve the accuracy of calibration through external sensors.

The detailed technology and preferred embodiments implemented for the subject disclosure are described in the following paragraphs accompanying the appended drawings for people skilled in this field to well appreciate the features of the claimed invention.

### BRIEF DESCRIPTION OF THE DRAWINGS

FIG. 1 is a schematic view depicting a tracking system of the first embodiment;

FIG. 2 is a schematic view depicting a tracking system of some embodiments;

FIG. 3 is a schematic view depicting a tracking system of some embodiments;

FIG. 4 is a schematic view depicting a tracking system of some embodiments;

FIG. 5 is a schematic view depicting a tracking system of some embodiments;

FIG. 6 is a schematic view depicting sensing signals of some embodiments;

FIG. 7 is a schematic view depicting historical signal power changes of some embodiments; and

FIG. 8 is a partial flowchart depicting a tracking method of the second embodiment.

### DETAILED DESCRIPTION

In the following description, a tracking system and method according to the present disclosure will be explained with reference to embodiments thereof. However, these embodiments are not intended to limit the present disclosure to any environment, applications, or implementations described in these embodiments. Therefore, description of these embodiments is only for purpose of illustration rather than to limit the present disclosure. It shall be appreciated that, in the following embodiments and the attached drawings, elements unrelated to the present disclosure are omitted from depiction. In addition, dimensions of individual elements and dimensional relationships among individual elements in the attached drawings are provided only for illustration but not to limit the scope of the present disclosure.

The application scenarios of the present disclosure are first described. In the present disclosure, a user can operate an interactive device (e.g., a gun-shaped device) in a physical environment to perform interactive operations related to other electronic devices (e.g., a head-mounted display (HMD)) and virtual reality, and the tracking system of the present disclosure tracks information such as the position and pose of the interactive device.

For example, a user can hold a gun-shaped device in his hand to play a game related to virtual reality and perform various pose operations. In this example, the gun-shaped device may have different positions and poses corresponding to different operations (e.g., holding the gun, loading the chamber, firing, and ejecting the shell). The tracking mechanism provided by the present disclosure will perform real-time and accurate tracking operations on the interactive device, and is not limited to fixed-position tracking operations (i.e., it is not necessary to wait for the tracking device to return to a preset point before tracking calibration can be performed).

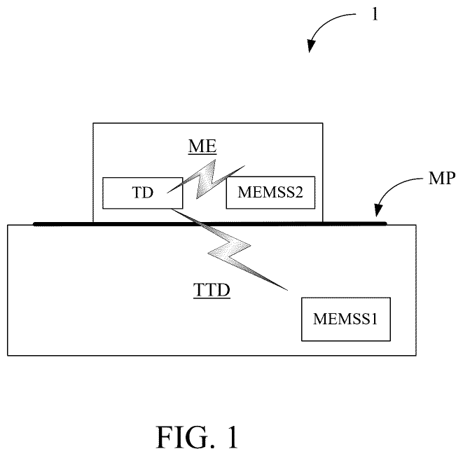

The first embodiment of the present disclosure is a tracking system 1, and a structure schematic diagram is depicted in FIG. 1. In the present embodiment, the tracking system 1 comprises a target device TTD (i.e., a target device to be tracked), a moving part MP, and a movable element ME.

In the present embodiment, the moving part MP comprises a movable path (e.g., a sliding track), and the movable element ME is disposed on the moving part MP. The movable element ME may perform controlled and constrained motion operations on the movable path (e.g., running along a sliding track).

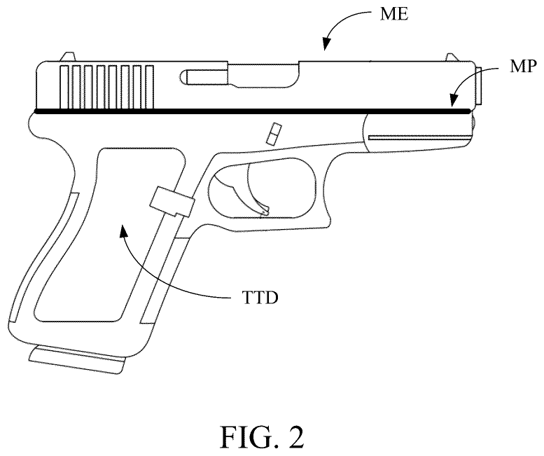

For easier understanding, please refer to FIG. 2. Taking a handheld gun-shaped device as an example, the target device TTD may be a grip portion of the handheld gun-shaped device, the movable element ME may be a slide portion of the handheld gun-shaped device, and the moving part MP may be a track on which the slide slides when in operation. The slide slides on the track to provide constrained and predictable motion operations for loading the chamber, ejecting the shell, etc.

It shall be appreciated that since the grip portion of the interactive device is easily held by the user or blocked by the mechanical structure, causing sensing failure (for example, tracking methods such as image vision and infrared), the tracking device will not be configured on the target device TTD. In the present disclosure, a tracking device TD is disposed on the movable element ME, and the correct pose of the target device TTD is calculated by reverse calculation by tracking the position of the movable element ME.

The present disclosure does not limit the type of interactive device. Any interactive device including a moving part MP, a movable element ME, and a target device TTD, and any interactive device having a fixed motion relationship (e.g., a fixed/reproducible motion trajectory) between the movable element ME and the target device TTD can implement the tracking mechanism of the present disclosure.

In the present embodiment, as shown in FIG. 1, the target device TTD comprises a first micro electro mechanical system sensor MEMSS1, and the first micro electro mechanical system sensor MEMSS1 is configured to generate a plurality of first sensing signals (e.g., acceleration values, angular velocity values) corresponding to the target device TTD.

In addition, the movable element ME comprises a tracking device TD and a second micro electro mechanical system sensor MEMSS2. The tracking device TD is configured to perform a tracking operation corresponding to the target device TTD, and the second micro electro mechanical system sensor MEMSS2 is configured to generate a plurality of second sensing signals corresponding to the movable element ME.

The first micro electro mechanical system sensor MEMSS1 and the second micro electro mechanical system sensor MEMSS2 can be connected to the tracking device TD via a wired network or a wireless network (e.g., a communication link).

It shall be appreciated that micro electro mechanical system sensors can be inertial measurement units (IMUs), accelerometers, gyroscopes, e-compass sensors, light sensors, infrared sensors, magnetic sensors, and other devices that can generate sensing data or signals. The micro electro mechanical system sensor can continuously generate relevant sensing signals (for example, at a frequency of 5 times per second) and transmit the sensing signals to the tracking device TD.

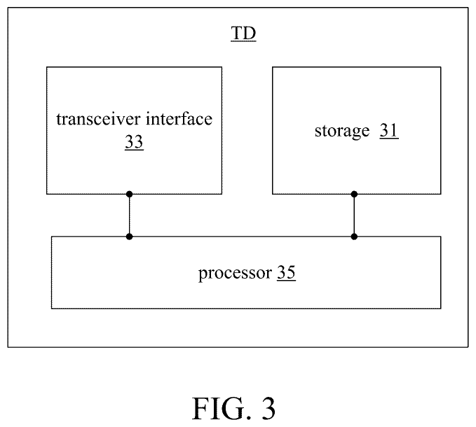

In some embodiments, as shown in FIG. 3, the tracking device TD may comprise at least a storage 31, a transceiver interface 33, and a processor 35, and the processor 35 is electrically connected to the storage 31 and the transceiver interface 33.

It shall be appreciated that the storage 31 may be a Universal Serial Bus (USB) disk, a hard disk, a Compact Disk (CD), a mobile disk, or any other storage medium or circuit known to those of ordinary skill in the art and having the same functionality. The transceiver interface 33 is an interface capable of receiving and transmitting data or other interfaces capable of receiving and transmitting data and known to those of ordinary skill in the art. The processor 35 may be any of various processors, Central Processing Units (CPUs), microprocessors, digital signal processors or other computing apparatuses known to those of ordinary skill in the art.

In some embodiments, the tracking device TD can be implemented by other devices in the environment with computing capabilities, such as a cloud computing device. In some embodiments, the second micro electro mechanical system sensor MEMSS2 may also be integrated into the tracking device TD.

In the present embodiment, the movable element ME performs a motion process along the movable path of the moving part MP, and the movable element ME and the target device TTD have a fixed motion relationship in the motion process. For example, a user holds a gun-shaped device to perform a firing operation, and the movable element ME (i.e., the slide) slides along the track on the moving part MP.

It shall be appreciated that since the movable element ME performs a controlled and constrained motion on the movable path of the moving part MP, the motion trajectory is predictable/reproducible and has a fixed sensing signal/motion trajectory that is close to the historical sensing signal/historical trajectory (i.e., the movable element ME and the target device TTD have a fixed motion relationship in the motion process).

Basically, the motion process of each pistol firing/ejecting operation is the same. Taking a gun-shaped device as an example, when performing the shell ejection operation, the slide follows a predictable sliding trajectory on the track, and there is a fixed motion relationship between the slide and the grip (for example: a fixed acceleration curve, fixed acceleration and rotation parameters at each time point), and different operations should have similar signal fluctuations/changes. Since the components move along the same trajectory, after completing the ejection/reloading operation, each component will return to its original position. Therefore, the noise of the generated signal is repeatable and the sensing signal is reproducible.

Next, in the present embodiment, the tracking device TD calculates a signal change at each of a plurality of time points corresponding to the motion process based on the first sensing signals and the second sensing signals. For example, the tracking device TD can preset the time points that need to be calibrated during the motion process, so as to perform active calibration operations at each time point.

Next, in the present embodiment, the tracking device TD generates a variable extrinsic calibration parameter of the target device TTD and the movable element ME corresponding to the time points based on the signal changes and the fixed motion relationship.

Finally, in the present embodiment, the tracking device TD performs a tracking operation corresponding to the target device TTD based on the variable extrinsic calibration parameters.

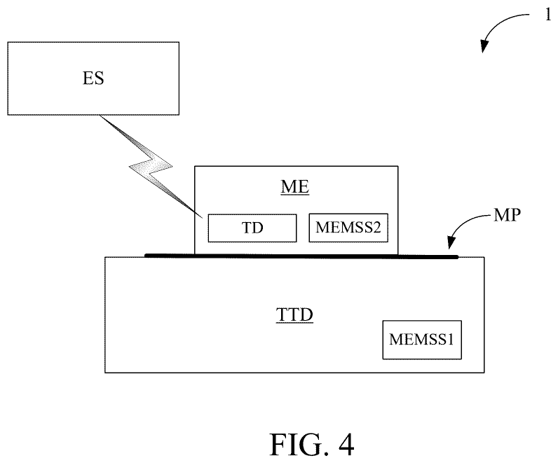

In some embodiments, the tracking system 1 can further confirm the positional relationship between the target device TTD and the movable element ME through an external device to improve the accuracy of the calibration (for example, determining which trajectory stage the movable element ME is currently in during the motion process). For example, as shown in FIG. 4, the tracking system 1 may further comprise an external sensor ES. The external sensor ES is communicatively connected to the tracking device TD, and the external sensor ES is comprises to generate a plurality of external sensing signals (e.g., infrared, visual images) corresponding to the target device TTD and the movable element ME.

In the present example, the tracking device TD receives the external sensing signals from the external sensor ES. The tracking device TD calculates a relative position of the target device TTD and the movable element ME corresponding to each of the time points based on the external sensing signals. The tracking device TD generates the variable extrinsic calibration parameters of the target device TTD and the movable element ME corresponding to each of the time points based on the relative positions and the signal changes.

In some embodiments, the moving part is a rotating shaft, and the movable element performs the motion process on the movable path on the rotating shaft.

In some embodiments, the moving part is a linear track, and the movable element performs the motion process on the movable path on the linear track.

In some embodiments, the moving part is an arc track, and the movable element performs the motion process on the movable path on the arc track.

In some embodiments, the tracking system 1 can further confirm the positional relationship between the target device TTD and the movable element ME in various directions (e.g., X-axis direction, Y-axis direction) through multiple external devices to improve the accuracy of calibration (e.g., determining which trajectory stage the movable element ME is currently in during the motion process).

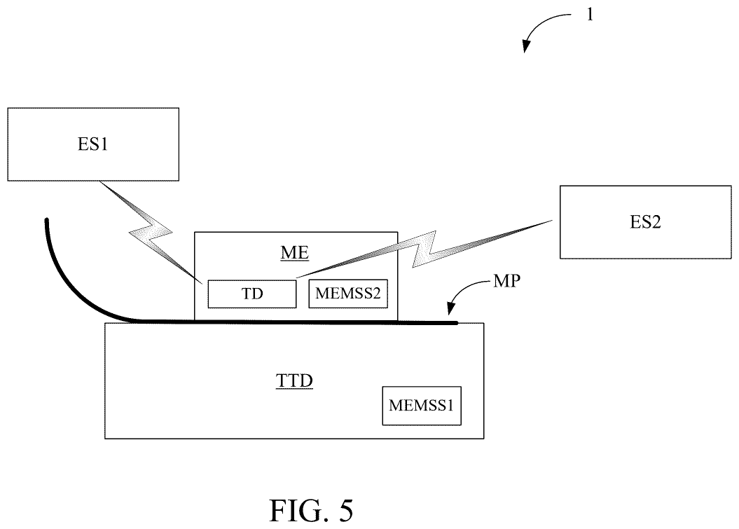

For example, as shown in FIG. 5, the tracking system 1 may further comprise a first external sensor ES1 and a second external sensor ES2, which are communicatively connected to the tracking device TD. In the present example, the first external sensor ES1 is configured to generate a plurality of first external sensing signals corresponding to a first direction (e.g., X-axis direction) of the target device TTD and the movable element ME. The second external sensor ES2 is configured to generate a plurality of second external sensing signals corresponding to a second direction (e.g., Y-axis direction) of the target device TTD and the movable element ME.

In the present example, the tracking device TD receives the first external sensing signals and the second external sensing signals. The tracking device TD calculates a relative position of the target device TTD and the movable element ME corresponding to each of the time points based on the first external sensing signals and the second external sensing signals. The tracking device TD generates the variable extrinsic calibration parameters of the target device TTD and the movable element ME corresponding to each of the time points based on the relative positions and the signal changes.

In some embodiments, the tracking device TD can confirm the position of the motion process by comparing the signal changes (e.g., signal differential) and historical signal changes to infer variable extrinsic calibration parameters. In some embodiments, the tracking device TD can determine the signal changes that are consistent with the historical signal changes through machine learning and deduce the corresponding variable extrinsic calibration parameters.

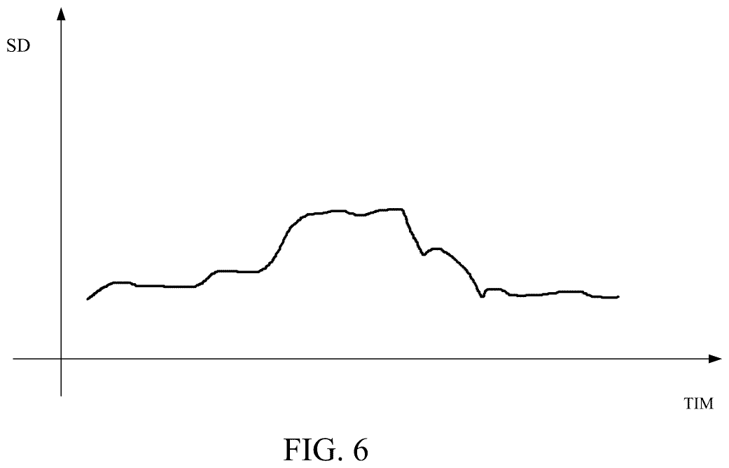

For example, FIG. 6 is a schematic diagram showing historical signal changes, where the vertical axis is the signal difference SD and the horizontal axis is the time TIM. The tracking device TD can compare the signal changes with the historical signal changes (for example, using a sliding window to compare whether the current signal pattern matches a certain interval in the historical signal changes) to determine the motion process position of the target device TTD and the movable element ME at each of the time points. Then, the tracking device TD generates the variable extrinsic calibration parameters of the target device TTD and the movable element ME corresponding to each of the time points based on the motion process position at each of the time points.

In some embodiments, the tracking device TD can confirm the motion process position by comparing the signal change (e.g., signal power) with the historical signal power change to deduce the variable extrinsic calibration parameter.

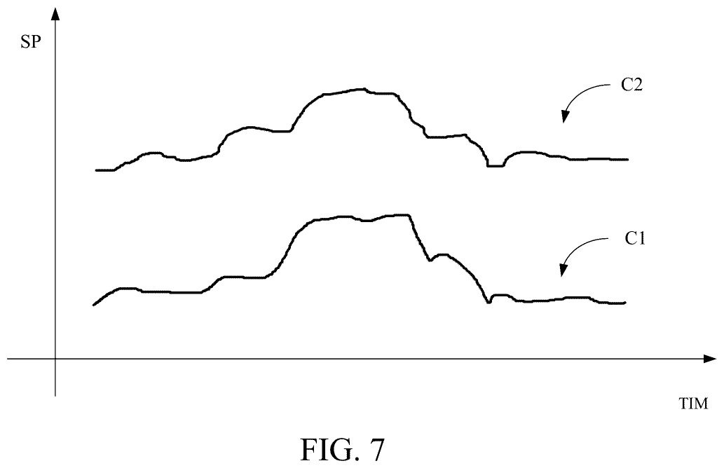

For example, FIG. 7 is a schematic diagram illustrating historical signal power changes, where the vertical axis is the signal power SP and the horizontal axis is the time TIM. The historical signal power schematic line C1 and the historical signal power schematic line C2 are the strengths of the signals collected by the first micro electro mechanical system sensor MEMSS1 and the second micro electro mechanical system sensor MEMSS2, respectively.

In the present example, the tracking device TD can compare the signal power currently collected from the sensor with the historical signal power schematic lines C1 and C2 to determine the motion process position of the target device TTD and the movable element ME at each of the time points. Then, the tracking device TD generates the variable extrinsic calibration parameters of the target device TTD and the movable element ME corresponding to each of the time points based on the motion process position of each of the time points.

In some embodiments, the tracking device TD may pre-store variable extrinsic calibration parameters corresponding to each time point to speed up the calibration calculation.

Specifically, the tracking device TD stores a historical variable extrinsic calibration parameter for each of a plurality of candidate motion process positions. The tracking device TD compares the motion process positions with the candidate motion process positions to select a plurality of target variable extrinsic calibration parameters from the historical variable extrinsic calibration parameters. Then, the tracking device TD generates the variable extrinsic calibration parameters of each of the time points based on the time points and the target variable extrinsic calibration parameters.

In some embodiments, the tracking device TD calibrates a target device pose of the target device TTD at each of the time points based on the variable extrinsic calibration parameters at each of the time points to perform the tracking operation corresponding to the target device TTD.

In some embodiments, the first micro electro mechanical system sensor and the second micro electro mechanical system sensor correspond to the same type of sensor, and the first sensing signals and the second sensing signals correspond to the same type of sensing signals (e.g., the sensing signals are all inertial sensing data generated by the inertial sensor).

According to the above descriptions, the tracking system 1 provided by the present disclosure limits the motion process of the target device to be tracked and the movable element (i.e., predefined moving parts and movable paths), so that the movable element and the target device to be tracked have a fixed motion relationship within the motion process. Next, the tracking system 1 disclosed in the present disclosure collects sensing signals through the micro electro mechanical system sensors disposed on the target device to be tracked and the movable element, and generates variable extrinsic calibration parameters of the target device and the movable element corresponding to each of a plurality of time points based on the signal changes. Finally, the tracking system 1 disclosed in the present disclosure can perform a tracking operation corresponding to the target device during the motion process (e.g., a plurality of preset calibration frequencies/time points) based on the variable extrinsic calibration parameters. Since the present disclosure can calibrate the target device to be tracked when the movable element performs a motion process, the problem that the target device to be tracked and the tracking device cannot be calibrated in the conventional technology is solved. In addition, the tracking system 1 provided by the present disclosure can also improve the accuracy of calibration through external sensors.

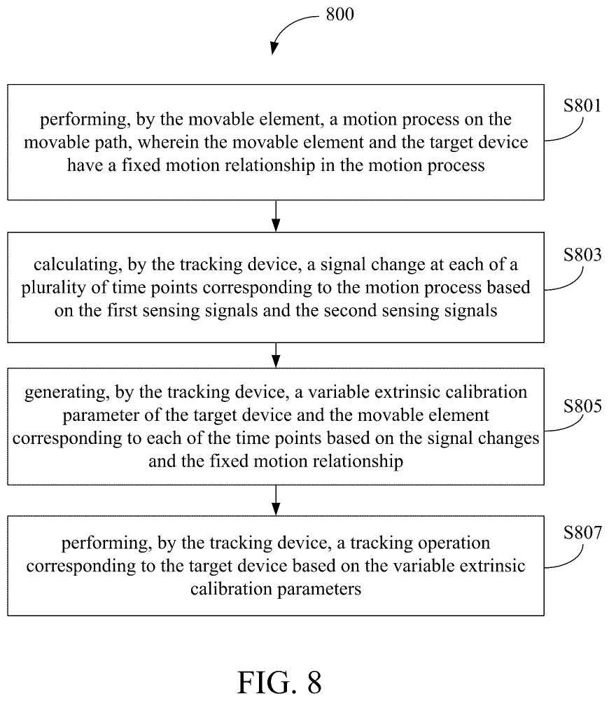

A second embodiment of the present disclosure is a tracking method and a flowchart thereof is depicted in FIG. 8. The tracking method 800 is adapted for a tracking system (e.g., the tracking system 1 of the first embodiment). The tracking system comprises a moving part, a target device, and a movable element (e.g., the moving part MP, the target device TTD, and the movable element ME of the first embodiment). The moving part comprises a movable path. The target device comprises a first micro electro mechanical system sensor, the first micro electro mechanical system sensor is configured to generate a plurality of first sensing signals. The movable element is disposed on the moving part, the movable element comprises a tracking device and a second micro electro mechanical system sensor, the second micro electro mechanical system sensor is configured to generate a plurality of second sensing signals. The tracking method 800 performs a tracking operation of the corresponding target device through steps S801 to S807.

In the step S801, the movable element performs a motion process on the movable path, wherein the movable element and the target device have a fixed motion relationship in the motion process. Next, in the step S803, the tracking device calculates a signal change at each of a plurality of time points corresponding to the motion process based on the first sensing signals and the second sensing signals.

Next, in the step S805, the tracking device generates a variable extrinsic calibration parameter of the target device and the movable element corresponding to each of the time points based on the signal changes and the fixed motion relationship.

Finally, in the step S807, the tracking device performs a tracking operation corresponding to the target device based on the variable extrinsic calibration parameters.

In some embodiments, the tracking system further comprises an external sensor, the external sensor is communicatively connected to the tracking device, the external sensor is configured to generate a plurality of external sensing signals corresponding to the target device and the movable element, and the tracking method further comprises the following steps: receiving the external sensing signals from the external sensor; calculating a relative position of the target device and the movable element corresponding to each of the time points based on the external sensing signals; and generating the variable extrinsic calibration parameter of the target device and the movable element corresponding to each of the time points based on the relative positions and the signal changes.

In some embodiments, the moving part is a rotating shaft, and the movable element performs the motion process on the movable path on the rotating shaft.

In some embodiments, the moving part is a linear track, and the movable element performs the motion process on the movable path on the linear track.

In some embodiments, the moving part is an arc track, and the movable element performs the motion process on the movable path on the arc track.

In some embodiments, the tracking system further comprises a first external sensor and a second external sensor, the first external sensor and the second external sensor are communicatively connected to the tracking device, the first external sensor is configured to generate a plurality of first external sensing signals corresponding to a first direction of the target device and the movable element; the second external sensor is configured to generate a plurality of second external sensing signals corresponding to a second direction of the target device and the movable element, and the tracking method further comprises the following steps: receiving the first external sensing signals and the second external sensing signals; calculating a relative position of the target device and the movable element corresponding to each of the time points based on the first external sensing signals and the second external sensing signals; and generating the variable extrinsic calibration parameter of the target device and the movable element corresponding to each of the time points based on the relative positions and the signal changes.

In some embodiments, the step of generating the variable extrinsic calibration parameter of the target device and the movable element corresponding to each of the time points further comprises the following steps: comparing the signal changes with a historical signal change to determine a motion process position of the target device and the movable element at each of the time points; and generating the variable extrinsic calibration parameter of the target device and the movable element corresponding to each of the time points based on the motion process position at each of the time points.

In some embodiments, the tracking device stores a historical variable extrinsic calibration parameter for each of a plurality of candidate motion process positions, and the step of generating the variable extrinsic calibration parameter of the target device and the movable element corresponding to each of the time points further comprises the following steps: comparing the motion process positions and the candidate motion process positions to select a plurality of target variable extrinsic calibration parameters from the historical variable extrinsic calibration parameters; and generating the variable extrinsic calibration parameter of each of the time points based on the time points and the target variable extrinsic calibration parameters.

In some embodiments, the step of performing the tracking operation corresponding to the target device comprises the following steps: calibrating a target device pose of the target device at each of the time points based on the variable extrinsic calibration parameter at each of the time points to perform the tracking operation corresponding to the target device.

In some embodiments, the first micro electro mechanical system sensor and the second micro electro mechanical system sensor correspond to the same type of sensor, and the first sensing signals and the second sensing signals correspond to the same type of sensing signal.

In addition to the aforesaid steps, the second embodiment can also execute all the operations and steps of the tracking system 1 set forth in the first embodiment, have the same functions, and deliver the same technical effects as the first embodiment. How the second embodiment executes these operations and steps, has the same functions, and delivers the same technical effects will be readily appreciated by those of ordinary skill in the art based on the explanation of the first embodiment. Therefore, the details will not be repeated herein.

The tracking method described in the second embodiment may be implemented by a computer program having a plurality of codes. The computer program may be a file that can be transmitted over the network, or may be stored into a non-transitory computer readable storage medium. After the codes of the computer program are loaded into an electronic system (e.g., the tracking system 1), the computer program executes the tracking method as described in the second embodiment. The non-transitory computer readable storage medium may be an electronic product, e.g., a read only memory (ROM), a flash memory, a floppy disk, a hard disk, a compact disk (CD), a mobile disk, a database accessible to networks, or any other storage medium with the same function and well known to those of ordinary skill in the art.

It shall be appreciated that in the specification and the claims of the present disclosure, some words (e.g., the micro electro mechanical system sensor, the sensing signal, the external sensor, the direction, the external sensing signal, etc.) are preceded by terms such as “first” and “second”, and these terms of “first” and “second” are only used to distinguish these different words. For example, the “first” and “second” sensing signals are only used to indicate the character categories used in different operations.

According to the above descriptions, the tracking technology (at least including the system and the method) provided by the present disclosure limits the motion process of the target device to be tracked and the movable element (i.e., predefined moving parts and movable paths), so that the movable element and the target device to be tracked have a fixed motion relationship within the motion process. Next, the tracking technology disclosed in the present disclosure collects sensing signals through the micro electro mechanical system sensors disposed on the target device to be tracked and the movable element, and generates variable extrinsic calibration parameters of the target device and the movable element corresponding to each of a plurality of time points based on the signal changes. Finally, the tracking technology disclosed in the present disclosure can perform a tracking operation corresponding to the target device during the motion process (e.g., a plurality of preset calibration frequencies/time points) based on the variable extrinsic calibration parameters. Since the present disclosure can calibrate the target device to be tracked when the movable element performs a motion process, the problem that the target device to be tracked and the tracking device cannot be calibrated in the conventional technology is solved. In addition, the tracking technology provided by the present disclosure can also improve the accuracy of calibration through external sensors.

The above disclosure is related to the detailed technical contents and inventive features thereof. People skilled in this field may proceed with a variety of modifications and replacements based on the disclosures and suggestions of the disclosure as described without departing from the characteristics thereof. Nevertheless, although such modifications and replacements are not fully disclosed in the above descriptions, they have substantially been covered in the following claims as appended.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A tracking system, comprising:
a moving part, wherein the moving part comprises a movable path;
a target device, wherein the target device comprises a first micro electro mechanical system sensor, and the first micro electro mechanical system sensor is configured to generate a plurality of first sensing signals; and
a movable element, being disposed on the moving part, wherein the movable element comprises a tracking device and a second micro electro mechanical system sensor, and the second micro electro mechanical system sensor is configured to generate a plurality of second sensing signals;
wherein the tracking system is configured to perform the following operations:
performing, by the movable element, a motion process on the movable path, wherein the movable element and the target device have a fixed motion relationship in the motion process;
calculating, by the tracking device, a signal change at each of a plurality of time points corresponding to the motion process based on the first sensing signals and the second sensing signals;
generating, by the tracking device, a variable extrinsic calibration parameter of the target device and the movable element corresponding to each of the time points based on the signal changes and the fixed motion relationship; and
performing, by the tracking device, a tracking operation corresponding to the target device based on the variable extrinsic calibration parameters.

2. The tracking system of claim 1, wherein the tracking system further comprises:
an external sensor, being communicatively connected to the tracking device, wherein the external sensor is configured to generate a plurality of external sensing signals corresponding to the target device and the movable element;
wherein the tracking device further performs the following operations:
receiving the external sensing signals from the external sensor;
calculating a relative position of the target device and the movable element corresponding to each of the time points based on the external sensing signals; and
generating the variable extrinsic calibration parameter of the target device and the movable element corresponding to each of the time points based on the relative positions and the signal changes.

3. The tracking system of claim 1, wherein the moving part is a rotating shaft, and the movable element performs the motion process on the movable path on the rotating shaft.

4. The tracking system of claim 1, wherein the moving part is a linear track, and the movable element performs the motion process on the movable path on the linear track.

5. The tracking system of claim 1, wherein the moving part is an arc track, and the movable element performs the motion process on the movable path on the arc track.

6. The tracking system of claim 5, wherein the tracking system further comprises:
a first external sensor, being communicatively connected to the tracking device, wherein the first external sensor is configured to generate a plurality of first external sensing signals corresponding to a first direction of the target device and the movable element; and
a second external sensor, being communicatively connected to the tracking device, wherein the second external sensor is configured to generate a plurality of second external sensing signals corresponding to a second direction of the target device and the movable element;
wherein the tracking device further performs the following operations:
receiving the first external sensing signals and the second external sensing signals;
calculating a relative position of the target device and the movable element corresponding to each of the time points based on the first external sensing signals and the second external sensing signals; and
generating the variable extrinsic calibration parameter of the target device and the movable element corresponding to each of the time points based on the relative positions and the signal changes.

7. The tracking system of claim 1, wherein the operation of generating the variable extrinsic calibration parameter of the target device and the movable element corresponding to each of the time points further comprises the following operations:
comparing the signal changes with a historical signal change to determine a motion process position of the target device and the movable element at each of the time points; and
generating the variable extrinsic calibration parameter of the target device and the movable element corresponding to each of the time points based on the motion process position at each of the time points.

8. The tracking system of claim 7, wherein the tracking device stores a historical variable extrinsic calibration parameter for each of a plurality of candidate motion process positions, and the operation of generating the variable extrinsic calibration parameter of the target device and the movable element corresponding to each of the time points further comprises the following operations:
comparing the motion process positions and the candidate motion process positions to select a plurality of target variable extrinsic calibration parameters from the historical variable extrinsic calibration parameters; and
generating the variable extrinsic calibration parameter of each of the time points based on the time points and the target variable extrinsic calibration parameters.

9. The tracking system of claim 1, wherein the operation of performing the tracking operation corresponding to the target device comprises the following operations:
calibrating a target device pose of the target device at each of the time points based on the variable extrinsic calibration parameter at each of the time points to perform the tracking operation corresponding to the target device.

10. The tracking system of claim 1, wherein the first micro electro mechanical system sensor and the second micro electro mechanical system sensor correspond to the same type of sensor, and the first sensing signals and the second sensing signals correspond to the same type of sensing signal.

11. A tracking method, being adapted for use in a tracking system, wherein the tracking system comprises a moving part, a target device, and a movable element, the moving part comprises a movable path, the target device comprises a first micro electro mechanical system sensor, the first micro electro mechanical system sensor is configured to generate a plurality of first sensing signals, the movable element is disposed on the moving part, the movable element comprises a tracking device and a second micro electro mechanical system sensor, the second micro electro mechanical system sensor is configured to generate a plurality of second sensing signals, and the tracking method comprises:
performing, by the movable element, a motion process on the movable path, wherein the movable element and the target device have a fixed motion relationship in the motion process;
calculating, by the tracking device, a signal change at each of a plurality of time points corresponding to the motion process based on the first sensing signals and the second sensing signals;
generating, by the tracking device, a variable extrinsic calibration parameter of the target device and the movable element corresponding to each of the time points based on the signal changes and the fixed motion relationship; and
performing, by the tracking device, a tracking operation corresponding to the target device based on the variable extrinsic calibration parameters.

12. The tracking method of claim 11, wherein the tracking system further comprises an external sensor, the external sensor is communicatively connected to the tracking device, the external sensor is configured to generate a plurality of external sensing signals corresponding to the target device and the movable element, and the tracking method further comprises the following steps:
receiving the external sensing signals from the external sensor;
calculating a relative position of the target device and the movable element corresponding to each of the time points based on the external sensing signals; and
generating the variable extrinsic calibration parameter of the target device and the movable element corresponding to each of the time points based on the relative positions and the signal changes.

13. The tracking method of claim 11, wherein the moving part is a rotating shaft, and the movable element performs the motion process on the movable path on the rotating shaft.

14. The tracking method of claim 11, wherein the moving part is a linear track, and the movable element performs the motion process on the movable path on the linear track.

15. The tracking method of claim 11, wherein the moving part is an arc track, and the movable element performs the motion process on the movable path on the arc track.

16. The tracking method of claim 15, wherein the tracking system further comprises a first external sensor and a second external sensor, the first external sensor and the second external sensor are communicatively connected to the tracking device, the first external sensor is configured to generate a plurality of first external sensing signals corresponding to a first direction of the target device and the movable element; the second external sensor is configured to generate a plurality of second external sensing signals corresponding to a second direction of the target device and the movable element, and the tracking method further comprises the following steps:
receiving the first external sensing signals and the second external sensing signals;
calculating a relative position of the target device and the movable element corresponding to each of the time points based on the first external sensing signals and the second external sensing signals; and
generating the variable extrinsic calibration parameter of the target device and the movable element corresponding to each of the time points based on the relative positions and the signal changes.

17. The tracking method of claim 11, wherein the step of generating the variable extrinsic calibration parameter of the target device and the movable element corresponding to each of the time points further comprises the following steps:
comparing the signal changes with a historical signal change to determine a motion process position of the target device and the movable element at each of the time points; and
generating the variable extrinsic calibration parameter of the target device and the movable element corresponding to each of the time points based on the motion process position at each of the time points.

18. The tracking method of claim 17, wherein the tracking device stores a historical variable extrinsic calibration parameter for each of a plurality of candidate motion process positions, and the step of generating the variable extrinsic calibration parameter of the target device and the movable element corresponding to each of the time points further comprises the following steps:
comparing the motion process positions and the candidate motion process positions to select a plurality of target variable extrinsic calibration parameters from the historical variable extrinsic calibration parameters; and
generating the variable extrinsic calibration parameter of each of the time points based on the time points and the target variable extrinsic calibration parameters.

19. The tracking method of claim 11, wherein the step of performing the tracking operation corresponding to the target device comprises the following steps:
calibrating a target device pose of the target device at each of the time points based on the variable extrinsic calibration parameter at each of the time points to perform the tracking operation corresponding to the target device.

20. The tracking method of claim 11, wherein the first micro electro mechanical system sensor and the second micro electro mechanical system sensor correspond to the same type of sensor, and the first sensing signals and the second sensing signals correspond to the same type of sensing signal.
